(19) United States
(12) Patent Application Publication
(10) Pub. No.: US 2018/0163069 A1
(43) Pub. Date: Jun. 14, 2018

(54) Conductive Paste

(71) Applicant: TATSUTA ELECTRIC WIRE & CABLE CO., LTD., Higashiosaka-shi, Osaka (JP)

(72) Inventor: Shinichi WAKITA, Higashiosaka-shi, Osaka (JP)

(21) Appl. No.: 15/574,907

(22) PCT Filed: Jun. 2, 2016
(86) PCT No.: PCT/JP2016/066475

§ 371 Date: Nov. 17, 2017

(30) Foreign Application Priority Data
Jun. 9, 2015 (JP) 2015-116858

(51) Int. Cl. C09D 11/52; C09D 11/037; C09D 11/102; C09D 5/24; C09D 7/40; C09D 7/62; C09D 175/04; C08G 18/58; C08G 18/73; C08G 18/22; H01B 1/22

(52) U.S. Cl. CPC C09D 11/52; C09D 11/037; C09D 11/102; C09D 5/24; C09D 7/70; C09D 7/62; C08K 7/00; C09D 175/04; C08G 18/58; C08G 18/73; C08G 18/222; H01B 1/22; C09D 7/69

(57) ABSTRACT

Provided is a solderable conductive paste that cures at low temperature, that is excellent in adhesiveness with an ITO layer, and that is inexpensive. The conductive paste of the present invention includes: flaky silver-coated copper powder; a phenoxy resin; a hexamethylene diisocyanate-based polyisocyanate compound and/or a blocked isocyanate compound; a phosphorus-containing organic titanate; and an alkanolamine, in which a content of the flaky silver-coated copper powder is from 88 parts by weight to 92 parts by weight with respect to 100 parts by weight of a total amount of the flaky silver-coated copper powder, the phenoxy resin, and the hexamethylene diisocyanate-based polyisocyanate compound and the blocked isocyanate compound.

### TECHNICAL FIELD

The present invention relates to a conductive paste.

### BACKGROUND ART

In recent years, a transparent conductive film has been used as, for example, an electrode of a touch sensor in a mobile device typified by a cellular phone. A transparent conductive film obtained by forming a transparent conductive layer including a metal oxide, such as an indium-tin composite oxide (ITO), on a transparent resin film (base material), such as a PET film, has been frequently used as the transparent conductive film. The transparent conductive layer including the ITO may be obtained by forming an ITO coating layer on the base material through vapor deposition or sputtering, and then etching the coating layer to form a circuit.

Various parts are typically mounted on the transparent conductive layer. No parts can be mounted on the transparent conductive layer including the ITO with solder, and hence a method involving fixing a part with a conductive adhesive has been used. In addition, for example, the following methods are used in some cases. A circuit formed of a silver paste is arranged around an ITO circuit in the transparent conductive layer, and a part is fixed onto the silver paste circuit through the conductive adhesive, or the part is mounted on the silver paste with solder.

However, when the conductive adhesive is used, a problem in that it is difficult to repair a part occurs. In addition, when a part is mounted on the silver paste with solder, a phenomenon in which silver is absorbed into the solder and hence the silver paste portion disappears (so-called silver erosion) is liable to occur, and solder containing a large amount of silver needs to be used for suppressing such phenomenon. Therefore, the method using the silver paste involves a problem that cost increases not only because the silver paste is expensive but also because expensive solder is used.

A conductive paste obtained by combining silver-coated copper powder cheaper than silver powder and a phenol resin has been proposed for solving the problems (Patent Literature 1). However, the conductive paste involves a problem that its curing temperature is high (e.g., 140° C. or more). When such conductive paste is applied onto the transparent conductive film, the base material of the transparent conductive film often shrinks at the time of the heat curing of the paste. In addition, the conductive paste including the phenol resin involves a problem that its adhesiveness with an ITO layer is insufficient.

### CITATION LIST

### Patent Literature

[PTL 1] JP 07-62274 A

### SUMMARY OF INVENTION

### Technical Problem

The present invention has been made to solve the conventional problems, and an object of the present invention is to provide a solderable conductive paste that cures at low temperature, that is excellent in adhesiveness with an ITO layer, and that is inexpensive.

### Solution to Problem

A conductive paste according to one embodiment of the present invention includes: flaky silver-coated copper powder; a phenoxy resin; a hexamethylene diisocyanate-based polyisocyanate compound and/or a blocked isocyanate compound; a phosphorus-containing organic titanate; and an alkanolamine, in which a content of the flaky silver-coated copper powder is from 88 parts by weight to 92 parts by weight with respect to 100 parts by weight of a total amount of the flaky silver-coated copper powder, the phenoxy resin, and the hexamethylene diisocyanate-based polyisocyanate compound and the blocked isocyanate compound.

In one embodiment, the flaky silver-coated copper powder has an average particle diameter of from 5 μm to 25 μm.

In one embodiment, the flaky silver-coated copper powder includes copper particles each serving as a core and silver coating layers configured to coat the copper particles, and a weight ratio of the silver coating layers is from 5 wt % to 20 wt % with respect to the copper particles.

In one embodiment, a content of the phenoxy resin is from 40 parts by weight to 65 parts by weight with respect to 100 parts by weight of a total amount of the phenoxy resin, and the hexamethylene diisocyanate-based polyisocyanate compound and the blocked isocyanate compound.

In one embodiment, a content of the phosphorus-containing organic titanate is from 1 part by weight to 3 parts by weight with respect to 100 parts by weight of the flaky silver-coated copper powder.

In one embodiment, a content of the alkanolamine is from 1 part by weight to 3 parts by weight with respect to 100 parts by weight of the flaky silver-coated copper powder.

### Advantageous Effects of Invention

According to the present invention, the conductive paste that cures at low temperature, that is excellent in solderability and adhesiveness with an ITO layer, and that is inexpensive can be obtained by: using a specific amount of flaky silver-coated copper powder as a conductive material; using a phenoxy resin as a binder component; and adding a hexamethylene diisocyanate-based polyisocyanate compound and/or a blocked isocyanate compound, a phosphorus-containing organic titanate, and an alkanolamine.

### DESCRIPTION OF EMBODIMENTS

A. Outline of Conductive Paste

A conductive paste of the present invention includes flaky silver-coated copper powder, a phenoxy resin, a hexamethylene diisocyanate-based polyisocyanate compound and/or a blocked isocyanate compound, a phosphorus-containing organic titanate, and an alkanolamine. The conductive paste of the present invention may be used by being applied to any appropriate film (e.g., a transparent conductive film) and then being cured. The conductive paste after the curing is excellent in solder wettability, and hence when the conductive paste is used, a part can be mounted by soldering. In addition, the conductive paste of the present invention is excellent in adhesiveness with ITO, and hence can be suitably used as, for example, a conductive paste to be applied onto an ITO layer formed on the transparent conductive film.

The flaky silver-coated copper powder functions as a conductive material. In the present invention, a conductive paste excellent in wettability to solder can be obtained by setting the content of the flaky silver-coated copper powder to a specific amount. Details about the foregoing are described later.

In addition, the phenoxy resin, the hexamethylene diisocyanate-based polyisocyanate compound, and the blocked isocyanate compound form a cross-linked body through a curing treatment, and the cross-linked body functions as a binder. In the present invention, a conductive paste that is excellent in adhesiveness with an ITO layer and can prevent erosion by solder can be obtained by using the phenoxy resin, and the hexamethylene diisocyanate-based polyisocyanate compound and/or the blocked isocyanate compound as binder components. In addition, a conductive paste that can cure at low temperature (e.g., 130° C. or less) can be obtained by using the binder components. When such conductive paste is used, the heat shrinkage of a transparent conductive film at the time of the curing of the paste on the transparent conductive film is suppressed. The conductive paste of the present invention exhibiting such effect is suitably used for a transparent conductive film including a base material having low heat resistance (e.g., a PET film base material).

Further, a conductive paste excellent in dispersibility of the flaky silver-coated copper powder and wettability to solder can be obtained by adding the phosphorus-containing organic titanate. In addition, the addition of the phosphorus-containing organic titanate improves the adhesiveness of the paste with an ITO layer.

A conductive paste obtained by combining the binder components and the phosphorus-containing organic titanate has such a characteristic as to hardly cause solder to pass therethrough. When such conductive paste is used, solder hardly reaches the back surface of the conductive paste (surface in contact with an ITO layer) at the time of soldering, and hence adhesiveness between the conductive paste and the ITO layer is maintained. That is, the conductive paste of the present invention shows an appropriate affinity for the ITO layer and has such a characteristic as to hardly cause solder to pass therethrough, and hence its adhesiveness with the ITO layer is extremely high.

B. Flaky Silver-Coated Copper Powder

The flaky silver-coated copper powder includes copper particles each serving as a core and silver coating layers configured to coat the copper particles. Each of the silver coating layers may coat part of the surface of a copper particle, or may coat the entirety of the surface of the copper particle. Each of the silver coating layers preferably coats the entirety of the surface of a copper particle. When the flaky silver-coated copper powder is used, a conductive paste that is excellent in wettability to solder and can be prevented from being eroded by solder can be obtained at low cost. In addition, the flaky silver-coated copper powder is advantageous because of its excellent dispersibility in the binder components.

The term “flaky” as used herein means a shape close to a flat plate or a thin rectangular parallelepiped, and specifically means a shape having an aspect ratio (major axis length L/thickness t) of 3 or more. An upper limit for the aspect ratio is, for example, 300. The major axis length L and thickness t of the flaky silver-coated copper powder can be measured by observing a scanning electron microscope (SEM) photograph obtained with a SEM.

The average particle diameter of the flaky silver-coated copper powder is preferably from 5 μm to 25 μm, more preferably from 5 μm to 20 μm, still more preferably from 7 μm to 20 μm. When the flaky silver-coated copper powder having an average particle diameter of 5 μm or more is used, a conductive paste that is prevented from being eroded by solder and is excellent in solderability can be obtained. In addition, when the flaky silver-coated copper powder having an average particle diameter of 25 μm or less is used, a conductive paste that can be easily subjected to fine line printing in screen printing can be obtained. The term “average particle diameter” means a particle diameter (primary particle diameter) at an integrated value of 50% in a particle size distribution obtained by a laser diffraction/scattering method.

In the flaky silver-coated copper powder, the weight ratio of the silver coating layers is preferably from 5 wt % to 20 wt %, more preferably from 7 wt % to 18 wt % with respect to the copper particles. When the weight ratio falls within such range, a conductive paste that has a low resistance and is inexpensive can be obtained.

The content of the flaky silver-coated copper powder is preferably from 88 parts by weight to 92 parts by weight with respect to 100 parts by weight of the total amount of the flaky silver-coated copper powder, the phenoxy resin, and the hexamethylene diisocyanate-based polyisocyanate compound and the blocked isocyanate compound. When the content falls within such range, a conductive paste excellent in wettability to solder can be obtained.

The flaky silver-coated copper powder may be produced by any appropriate method. For example, the flaky silver-coated copper powder may be obtained by: pulverizing spherical particles with any appropriate pulverizing mill to provide flaky copper powder; and then coating the copper powder with silver by a method such as a substitution reduction method.

C. Binder Components

### (Phenoxy Resin)

The phenoxy resin is an epoxy resin obtained by causing a bisphenol compound and an epihalohydrin to react with each other. The phenoxy resin may contain two or more epoxy groups in a molecule thereof. A resin having a large molecular weight (polymerization degree) is preferably used as the phenoxy resin. The weight-average molecular weight of the phenoxy resin is, for example, 10,000 or more, preferably 30,000 or more, more preferably 35,000 or more, still more preferably from 35,000 to 600,000. The use of a high-molecular weight phenoxy resin can provide a conductive paste with excellence in heat resistance. In addition, a high-molecular weight epoxy resin is advantageous because the resin tends to easily cure (have a low curing temperature and a short curing time). The weight-average molecular weight may be measured by GPC (solvent: THF).

Examples of the phenoxy resin include a bisphenol A-type phenoxy resin obtained by using bisphenol A as the bisphenol compound and a bisphenol F-type phenoxy resin obtained by using bisphenol F as the bisphenol compound. Of those, a bisphenol A-type phenoxy resin is preferably used. When the bisphenol A-type phenoxy resin is used, an improving effect on the adhesiveness of the conductive paste with an ITO layer and a preventing effect on erosion by solder become significant.

The content of the phenoxy resin is preferably from 40 wt % to 65 wt %, more preferably from 50 wt % to 60 wt % with respect to the total amount of the phenoxy resin, and the hexamethylene diisocyanate-based polyisocyanate compound and the blocked isocyanate compound. When the content falls within such range, a conductive paste that is prevented from being eroded by solder and is excellent in solderability can be obtained.

(Hexamethylene Diisocyanate-Based Polyisocyanate Compound)

A biuret-type or isocyanurate-type hexamethylene diisocyanate-based polyisocyanate compound may be used as the hexamethylene diisocyanate-based polyisocyanate compound. An isocyanurate-type hexamethylene diisocyanate-based polyisocyanate compound (general formula (1)) is preferably used.

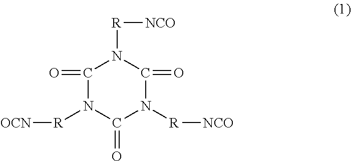

In the formula (1), R represents a hexamethylene group.

The content of the hexamethylene diisocyanate-based polyisocyanate compound is preferably from 35 parts by weight to 60 parts by weight, more preferably from 40 parts by weight to 50 parts by weight with respect to 100 parts by weight of the total amount of the phenoxy resin, and the hexamethylene diisocyanate-based polyisocyanate compound and the blocked isocyanate compound. In addition, the hexamethylene diisocyanate-based polyisocyanate compound and the blocked isocyanate compound may be used in combination. In this case, the total content of the hexamethylene diisocyanate-based polyisocyanate compound and the blocked isocyanate compound is preferably from 35 parts by weight to 60 parts by weight, more preferably from 40 parts by weight to 50 parts by weight with respect to 100 parts by weight of the total amount of the phenoxy resin, and the hexamethylene diisocyanate-based polyisocyanate compound and the blocked isocyanate compound.

(Blocked Isocyanate Compound)

Any appropriate compound may be used as the blocked isocyanate compound as long as the effects of the present invention are obtained. The blocked isocyanate compound is, for example, a compound obtained by causing an isocyanate group of an isocyanate compound and a blocking agent to react with each other, the isocyanate group being protected with the blocking agent. The use of the blocked isocyanate compound can improve the pot life of the conductive paste.

Examples of the isocyanate compound include tolylene diisocyanate (TDI), diphenylmethane diisocyanate (MDI), hexamethylene diisocyanate (HDI), and isophorone diisocyanate (IPDI). Examples of the blocking agent may include an oxime compound, a lactam compound, a phenol compound, an alcohol compound, an amine compound, an active methylene compound, a pyrazole compound, a mercaptan compound, an imidazole-based compound, and an imide-based compound.

The content of the blocked isocyanate compound is preferably from 35 parts by weight to 60 parts by weight, more preferably from 40 parts by weight to 50 parts by weight with respect to 100 parts by weight of the total amount of the phenoxy resin, and the hexamethylene diisocyanate-based polyisocyanate compound and the blocked isocyanate compound.

D. Phosphorus-Containing Organic Titanate

Examples of the phosphorus-containing organic titanate include tetra(2,2-diallyloxymethyl-1-butyl) bis(di-tridecyl)phosphite titanate, bis(dioctyl pyrophosphate)oxyacetate titanate, tetraoctyl bis(ditridecyl phosphite) titanate, tetraisopropyl bis(dioctyl phosphite) titanate, isopropyl tris(dioctyl pyrophosphate) titanate, and bis(dioctyl pyrophosphate) ethylene titanate. Of those, a phosphorus-containing organic titanate having a phosphate group is preferably used, and bis(dioctyl pyrophosphate)oxyacetate titanate is more preferably used.

The content of the phosphorus-containing organic titanate is preferably from 1 part by weight to 3 parts by weight, more preferably from 1.5 parts by weight to 2.5 parts by weight with respect to 100 parts by weight of the flaky silver-coated copper powder. When the content falls within such range, a conductive paste excellent in wettability to solder can be obtained.

E. Alkanolamine

The alkanolamine can exhibit a function as flux at the time of the performance of soldering on the conductive paste, and in particular, can contribute to an improvement in wettability to solder. In addition, the use of the alkanolamine can provide a conductive paste that is prevented from being eroded by solder and is excellent in solderability. Further, the alkanolamine can form a protective film on the surface of the flaky silver-coated copper powder.

The alkanolamine may be a monoalkanolamine, a dialkanolamine, or a trialkanolamine. Examples of the alkanolamine include monoethanolamine, diethanolamine, triethanolamine, and monopropanolamine. Of those, triethanolamine is preferred. The use of triethanolamine can provide a conductive paste with more excellence in wettability to solder.

The content of the alkanolamine is preferably from 1 part by weight to 3 parts by weight, more preferably from 1.5 parts by weight to 2.5 parts by weight with respect to 100 parts by weight of the flaky silver-coated copper powder. When the content falls within such range, a conductive paste excellent in wettability to solder can be obtained.

F. Other Additive

The conductive paste of the present invention may further include any appropriate other additive. Examples of the other additive may include a defoaming agent, an antioxidant, a viscosity modifier, a diluent, an anti-settling agent, a leveling agent, and a coupling agent.

In one embodiment, the conductive paste further includes a defoaming agent. Examples of the defoaming agent include a silicone-based defoaming agent and an acrylic defoaming agent. The addition amount of the defoaming agent is not limited, but is preferably the minimum amount needed for defoaming at the time of screen printing.

The conductive paste may include a solvent. A solvent that can dissolve the binder components (the phenoxy resin, the hexamethylene diisocyanate-based polyisocyanate compound, and the blocked isocyanate compound) in the conductive paste may be preferably used as the solvent. In addition, a solvent having such a vapor pressure and boiling point that continuous printing can be performed at the time of the screen printing of the conductive paste may be preferably used. Examples of the solvent include organic solvents, such as butyl carbitol, ethyl carbitol, and γ-butyrolactone. The solvents may be used alone or in combination thereof.

G. Method of Producing Conductive Paste

The conductive paste of the present invention may be produced by any appropriate method. For example, the paste may be obtained by: dissolving the phenoxy resin in the solvent to prepare a varnish; adding and stirring the flaky silver-coated copper powder, the binder components, the phosphorus-containing organic titanate, and the alkanolamine to the varnish. The respective components may be added in any appropriate order. A method involving using a rotation-revolution mixer, a triple roll, a kneader, or the like may be adopted as a method of stirring the respective components.

The conductive paste of the present invention may be typically used by being applied onto a transparent conductive film. For example, the conductive paste is used by: being applied onto a transparent conductive layer (e.g., an ITO layer) formed on the transparent conductive film by any appropriate method; and then being cured by heating. Examples of the application method include: printing methods, such as a screen printing method, a flexographic printing method, and a gravure printing method; and a spray method, brush coating, and a bar coating method. Of those, a screen printing method is preferably used.

As described above, the conductive paste of the present invention can cure at low temperature. The curing temperature of the conductive paste is preferably 130° C. or less, more preferably 120° C. or less, still more preferably 80° C. or more and less than 100° C. In addition, a time period for the heat curing is, for example, from 10 minutes to 60 minutes.

### EXAMPLES

The present invention is specifically described below by way of Examples, but the present invention is not limited to these Examples. In addition, in Examples, “part(s)” and “%” are by weight unless otherwise specified.

### Example 1

6.7 Parts by weight of a phenoxy resin (manufactured by Mitsubishi Chemical Corporation, product name: “jER1256”, bisphenol A-type phenoxy resin, weight-average molecular weight: 50,000), 4.4 parts by weight of a hexamethylene diisocyanate-based polyisocyanate compound (isocyanurate type, NCO %: 23.1 wt %), and butyl carbitol were mixed to prepare a varnish.

A conductive paste was obtained by adding 100 parts by weight of flaky silver-coated copper powder (average particle diameter: 8 μm to 10 μm, silver coating amount: 15 wt %, aspect ratio: 45), 1 part by weight of triethanolamine, 1 part by weight of a phosphorus-containing organic titanate (bis(dioctylpyrophosphate)oxyacetate titanate), and a defoaming agent to the varnish (solid content: 11.1 parts by weight).

### Example 2

A conductive paste was obtained in the same manner as in Example 1 except that: the blending amount of triethanolamine was changed to 1.5 parts by weight; and the blending amount of the phosphorus-containing organic titanate (bis(dioctylpyrophosphate)oxyacetate titanate) was changed to 1.5 parts by weight.

### Example 3

A conductive paste was obtained in the same manner as in Example 1 except that: the blending amount of triethanolamine was changed to 2 parts by weight; and the blending amount of the phosphorus-containing organic titanate (bis(dioctylpyrophosphate)oxyacetate titanate) was changed to 2 parts by weight.

### Example 4

A conductive paste was obtained in the same manner as in Example 1 except that: the blending amount of triethanolamine was changed to 2.5 parts by weight; and the blending amount of the phosphorus-containing organic titanate (bis(dioctylpyrophosphate)oxyacetate titanate) was changed to 2.5 parts by weight.

### Example 5

A conductive paste was obtained in the same manner as in Example 1 except that: the blending amount of triethanolamine was changed to 3 parts by weight; and the blending amount of the phosphorus-containing organic titanate (bis(dioctylpyrophosphate)oxyacetate titanate) was changed to 3 parts by weight.

### Example 6

7.2 Parts by weight of a phenoxy resin (manufactured by Mitsubishi Chemical Corporation, product name: “jER1256”, bisphenol A-type phenoxy resin, weight-average molecular weight: 50,000), 3.9 parts by weight of a hexamethylene diisocyanate-based polyisocyanate compound (isocyanurate type, NCO %: 23.1 wt %), and butyl carbitol were mixed to prepare a varnish.

A conductive paste was obtained by adding 100 parts by weight of flaky silver-coated copper powder (average particle diameter: 8 μm to 10 μm, silver coating amount: 15 wt %, aspect ratio: 45), 2.5 parts by weight of triethanolamine, 2.5 parts by weight of a phosphorus-containing organic titanate (bis(dioctylpyrophosphate)oxyacetate titanate), and a defoaming agent to the varnish (solid content: 11.1 parts by weight).

### Example 7

A conductive paste was obtained in the same manner as in Example 6 except that: the blending amount of the phenoxy resin (manufactured by Mitsubishi Chemical Corporation, product name: “jER1256”, bisphenol A-type phenoxy resin, weight-average molecular weight: 50,000) was changed to 6.7 parts by weight; and the blending amount of the hexamethylene diisocyanate-based polyisocyanate compound (isocyanurate type, NCO %: 23.1 wt %) was changed to 4.4 parts by weight.

### Example 8

A conductive paste was obtained in the same manner as in Example 6 except that: the blending amount of the phenoxy resin (manufactured by Mitsubishi Chemical Corporation, product name: “jER1256”, bisphenol A-type phenoxy resin, weight-average molecular weight: 50,000) was changed to 6.1 parts by weight; and the blending amount of the hexamethylene diisocyanate-based polyisocyanate compound (isocyanurate type, NCO %: 23.1 wt %) was changed to 5.0 parts by weight.

### Example 9

6.6 Parts by weight of a phenoxy resin (manufactured by Mitsubishi Chemical Corporation, product name: “jER1256”, bisphenol A-type phenoxy resin, weight-average molecular weight: 50,000), 4.9 parts by weight of a hexamethylene diisocyanate-based polyisocyanate compound (isocyanurate type, NCO %: 23.1 wt %), and butyl carbitol were mixed to prepare a varnish.

A conductive paste was obtained by adding 100 parts by weight of flaky silver-coated copper powder (average particle diameter: 8 μm to 10 μm, silver coating amount: 15 wt %, aspect ratio: 45), 2.5 parts by weight of triethanolamine, and 2.5 parts by weight of a phosphorus-containing organic titanate (bis(dioctylpyrophosphate)oxyacetate titanate) to the varnish (solid content: 11.5 parts by weight).

### Example 10

A conductive paste was obtained in the same manner as in Example 9 except that 4.9 parts by weight of a blocked isocyanate compound (manufactured by Asahi Kasei Chemicals Corporation, product name: “DURANATE SBN-70D”) was used instead of 4.9 parts by weight of the hexamethylene diisocyanate-based polyisocyanate compound (isocyanurate type, NCO %: 23.1 wt %).

### Example 11

A conductive paste was obtained in the same manner as in Example 9 except that 100 parts by weight of flaky silver-coated copper powder (average particle diameter: 5 μm to 7 μm, silver coating amount: 5 wt %, aspect ratio: 30) was used instead of 100 parts by weight of the flaky silver-coated copper powder (average particle diameter: 8 μm to 10 μm, silver coating amount: 15 wt %, aspect ratio: 45).

### Comparative Example 1

A conductive paste was obtained in the same manner as in Example 1 except that triethanolamine and the phosphorus-containing organic titanate were not added.

### Comparative Example 2

A conductive paste was obtained in the same manner as in Comparative Example 1 except that: the blending amount of the phenoxy resin (manufactured by Mitsubishi Chemical Corporation, product name: “jER1256”, bisphenol A-type phenoxy resin, weight-average molecular weight: 50,000) was changed to 8.2 parts by weight; and the blending amount of the hexamethylene diisocyanate-based polyisocyanate compound (isocyanurate type, NCO %: 23.1 wt %) was changed to 5.5 parts by weight.

### Comparative Example 3

A conductive paste was obtained in the same manner as in Example 9 except that 100 parts by weight of spherical silver-coated copper powder (average particle diameter: 6 μm to 10 μm, silver coating amount: 10 wt %) was used instead of 100 parts by weight of the flaky silver-coated copper powder.

### Comparative Example 4

A conductive paste was obtained in the same manner as in Example 9 except that 100 parts by weight of flaky silver powder (average particle diameter: 7 μm to 15 μm, aspect ratio: 55) was used instead of 100 parts by weight of the flaky silver-coated copper powder.

### Comparative Example 5

A conductive paste was obtained in the same manner as in Example 9 except that 100 parts by weight of flaky copper powder (average particle diameter: 8 μm to 10 μm, aspect ratio: 45) was used instead of 100 parts by weight of the flaky silver-coated copper powder.

### Comparative Example 6

4.9 Parts by weight of a phenoxy resin (manufactured by Mitsubishi Chemical Corporation, product name: “jER1256”, bisphenol A-type phenoxy resin, weight-average molecular weight: 50,000), 3.2 parts by weight of a hexamethylene diisocyanate-based polyisocyanate compound (isocyanurate type, NCO %: 23.1 wt %), and butyl carbitol were mixed to prepare a varnish.

A conductive paste was obtained by adding 100 parts by weight of flaky silver-coated copper powder (average particle diameter: 8 μm to 10 μm, silver coating amount: 15 wt %, aspect ratio: 45), 2.5 parts by weight of triethanolamine, 2.5 parts by weight of a phosphorus-containing organic titanate (bis(dioctylpyrophosphate)oxyacetate titanate), and a defoaming agent to the varnish (solid content: 8.1 parts by weight).

### Comparative Example 7

11.5 Parts by weight of a phenol resin (manufactured by Gun Ei Chemical Industry Co., Ltd., product name: “RESITOP PL4348”) and butyl carbitol were mixed to prepare a varnish. A conductive paste was obtained in the same manner as in Example 9 except that the varnish was used.

<Evaluation>

The conductive pastes obtained in Examples and Comparative Examples were subjected to the following evaluations. The results are shown in Table 1.

(1) Volume Resistivity

A conductive paste was printed in a line shape between two copper electrodes formed on a glass epoxy substrate, and then the conductive paste was heated with an air oven (Examples 1 to 11 and Comparative Examples 1 to 6: at 120° C. for 30 minutes, Comparative Example 7: at 160° C. for 30 minutes) to be cured. Thus, a measurement sample was obtained.

Screen printing was adopted for the printing, and a 180-mesh Tetron screen having an emulsion thickness of 30 μm was used. 10 Lines each having a size measuring 1 mm wide by 70 mm long were formed.

A resistance value between the electrodes was measured by a four-terminal method. A volume resistivity was determined from the resultant resistance value by using the following equation. A coating film thickness (D) is the average of the thicknesses of the 10 lines, and a measured resistance value (R) is the average of the measured resistance values of the 10 lines.

Volume resistivity σ=W×D×R/L

σ: volume resistivity (Ω·cm)

W: coating film width (cm)

D: coating film thickness (cm) (average of the coating film thicknesses of the 10 lines)

L: coating film length (cm)

R: measured resistance value (Ω) (average of the measured resistance values of the 10 lines)

(2) Acetone Rubbing Test

A measurement sample was obtained in the same manner as in the (1). A paper towel impregnated with acetone was reciprocated on a line-shaped conductive paste 5 times, and whether or not the paste was wiped off was confirmed and evaluated by the following criteria.

∘: No paste is wiped off.

Δ: The paste is slightly wiped off.

x: The paste is completely wiped off.

(3) Solderability Test

A conductive paste is printed on a one-surface copper-clad glass epoxy substrate by using a 180-mesh Tetron screen having an emulsion thickness of 30 μm so as to have an area measuring 15 mm by 20 mm. After the screen printing, the resultant is cured by heating with an air oven (Examples 1 to 11 and Comparative Examples 1 to 6: at 120° C. for 30 minutes, Comparative Example 7: at 160° C. for 30 minutes), and is then cooled to room temperature. The cooled product is used as a sample. The sample was immersed in 63Sn/37Pb solder heated to 265±5° C. for 3 seconds and removed. After that, the solder wettability of the paste measuring 15 mm by 20 mm was evaluated.

∘: Solder wet area of 80% or more

Δ: Solder wet area of 50% or more and less than 80%

Δ to x: Solder wet area of 20% or more and less than 50%

x: Solder wet area of less than 20%

(4) Adhesiveness with ITO

A conductive paste was applied onto an ITO substrate, and then the applied layer was heated (Examples 1 to 11 and Comparative Examples 1 to 6: at 120° C. for 30 minutes, Comparative Example 7: at 160° C. for 30 minutes) to be cured. Thus, an evaluation sample was produced.

Adhesiveness between the conductive paste and ITO was evaluated through the use of the evaluation sample by the cross-cut peeling test of JIS K 5600. Specifically, notches were made in a 10-millimeter square on the surface of the conductive paste at intervals of 1 mm with a box cutter to produce 100 grids. A pressure-sensitive adhesive tape was bonded onto the grids and then peeled. The number of grids that had peeled from the ITO substrate was measured, and the adhesiveness was evaluated by the following criteria.

∘: Number of peeled grids of less than 1

Δ: Number of peeled grids of 1 or more and less than 99

x: Number of peeled grids of 99 or more

TABLE 1

| | | | Example 1 | Example 2 | Example 3 | Example 4 | Example 5 | Example 6 | Example 7 | Example 8 |
|---|---|---|---|---|---|---|---|---|---|---|
| Powder | Blending | Flaky silver-coated | 100 | 100 | 100 | 100 | 100 | 100 | 100 | 100 |
| | amount | copper powder | | | | | | | | |
| | | (part(s) by weight) | | | | | | | | |
| | | Average particle | | | | | | | | |
| | | diameter: 8 μm to 10 μm | | | | | | | | |
| | | Silver coating | | | | | | | | |
| | | amount: 15 wt % | | | | | | | | |
| | | Flaky silver-coated | | | | | | | | |
| | | copper powder | | | | | | | | |
| | | (part(s) by weight) | | | | | | | | |
| | | Average particle | | | | | | | | |
| | | diameter: 5 μm to 7 μm | | | | | | | | |
| | | Silver coating | | | | | | | | |
| | | amount: 5 wt % | | | | | | | | |
| | | Spherical | | | | | | | | |
| | | silver-coated copper | | | | | | | | |
| | | powder (part(s) by | | | | | | | | |
| | | weight) | | | | | | | | |
| | | Average particle | | | | | | | | |
| | | diameter: 6 μm to 10 | | | | | | | | |
| | | μm | | | | | | | | |
| | | Silver coating | | | | | | | | |
| | | amount: 10 wt % | | | | | | | | |
| | | Flaky silver powder | | | | | | | | |
| | | (part(s) by weight) | | | | | | | | |
| | | Average particle | | | | | | | | |
| | | diameter: 7 μm to 15 μm | | | | | | | | |
| | | Flaky copper powder | | | | | | | | |
| | | (part(s) by weight) | | | | | | | | |
| | | Average particle | | | | | | | | |
| | | diameter: 8 μm to 10 μm | | | | | | | | |
| | Content of powder (wt % with | | 90 | 90 | 90 | 90 | 90 | 90 | 90 | 90 |
| | respect to the total of | | | | | | | | | |
| | binder components and | | | | | | | | | |
| | powder) | | | | | | | | | |
| Binder | Blending | Phenoxy resin | 6.7 | 6.7 | 6.7 | 6.7 | 6.7 | 7.2 | 6.7 | 6.1 |
| component | amount | (part(s) by weight) | | | | | | | | |
| | | Phenol resin (part(s) | — | — | — | — | — | — | — | — |
| | | by weight) | | | | | | | | |
| | | HDI-based | 4.4 | 4.4 | 4.4 | 4.4 | 4.4 | 3.9 | 4.4 | 5.0 |
| | | polyisocyanate | | | | | | | | |
| | | (part(s) by weight) | | | | | | | | |
| | | Blocked isocyanate | — | — | — | — | — | — | — | — |
| | | (part(s) by weight) | | | | | | | | |

| | Content of phenoxy resin | 60 | 60 | 60 | 60 | 60 | 65 | 60 | 55 |
|---|---|---|---|---|---|---|---|---|---|
| | (wt % with respect to the | | | | | | | | |
| | entirety of binder | | | | | | | | |
| | components) | | | | | | | | |
| Blending amount of | | 1 | 1.5 | 2 | 2.5 | 3 | 2.5 | 2.5 | 2.5 |
| triethanolamine (part(s) by | | | | | | | | | |
| weight) | | | | | | | | | |
| Blending amount of | | 1 | 1.5 | 2 | 2.5 | 3 | 2.5 | 2.5 | 2.5 |
| phosphorus-containing organic | | | | | | | | | |
| titanate (part(s) by weight) | | | | | | | | | |
| Evaluation | Volume resistivity (×10⁻⁴ | 3.3 | 2.7 | 2.6 | 2.6 | 2.8 | 2.8 | 2.6 | 2.7 |
| | Ω · cm) | | | | | | | | |
| | Acetone rubbing test | ∘ | ∘ | ∘ | ∘ | Δ | ∘ | ∘ | ∘ |
| | Solderability test | ∘ | ∘ | ∘ | ∘ | ∘ | ∘ | ∘ | ∘ |
| | Adhesiveness with ITO | ∘ | ∘ | ∘ | ∘ | ∘ | ∘ | ∘ | ∘ |

| | | | | | | Comparative | Comparative | Comparative |
|---|---|---|---|---|---|---|---|---|
| | | | Example 9 | Example 10 | Example 11 | Example 1 | Example 2 | Example 3 |
| Powder | Blending | Flaky silver-coated | 100 | 100 | | 100 | 100 | |
| | amount | copper powder | | | | | | |
| | | (part(s) by weight) | | | | | | |
| | | Average particle | | | | | | |
| | | diameter: 8 μm to 10 μm | | | | | | |
| | | Silver coating | | | | | | |
| | | amount: 15 wt % | | | | | | |
| | | Flaky silver-coated | | | 100 | | | |
| | | copper powder | | | | | | |
| | | (part(s) by weight) | | | | | | |
| | | Average particle | | | | | | |
| | | diameter: 5 μm to 7 μm | | | | | | |
| | | Silver coating | | | | | | |
| | | amount: 5 wt % | | | | | | |
| | | Spherical | | | | | | 100 |
| | | silver-coated copper | | | | | | |
| | | powder (part(s) by | | | | | | |
| | | weight) | | | | | | |
| | | Average particle | | | | | | |
| | | diameter: 6 μm to 10 | | | | | | |
| | | μm | | | | | | |
| | | Silver coating | | | | | | |
| | | amount: 10 wt % | | | | | | |
| | | Flaky silver powder | | | | | | |
| | | (part(s) by weight) | | | | | | |
| | | Average particle | | | | | | |
| | | diameter: 7 μm to 15 μm | | | | | | |
| | | Flaky copper powder | | | | | | |
| | | (part(s) by weight) | | | | | | |
| | | Average particle | | | | | | |
| | | diameter: 8 μm to 10 μm | | | | | | |
| | Content of powder (wt % with | | 90 | 90 | 90 | 90 | 88 | 90 |
| | respect to the total of | | | | | | | |
| | binder components and | | | | | | | |
| | powder) | | | | | | | |
| Binder | Blending | Phenoxy resin | 6.6 | 6.6 | 6.6 | 6.7 | 8.2 | 6.6 |
| component | amount | (part(s) by weight) | | | | | | |
| | | Phenol resin (part(s) | — | — | — | — | — | — |
| | | by weight) | | | | | | |
| | | HDI-based | 4.9 | — | 4.9 | 4.4 | 5.5 | 4.9 |
| | | polyisocyanate | | | | | | |
| | | (part(s) by weight) | | | | | | |
| | | Blocked isocyanate | — | 4.9 | — | — | — | — |
| | | (part(s) by weight) | | | | | | |

| | Content of phenoxy resin | 57 | 57 | 57 | 60 | 60 | 57 |
|---|---|---|---|---|---|---|---|
| | (wt % with respect to the | | | | | | |
| | entirety of binder | | | | | | |
| | components) | | | | | | |
| Blending amount of | | 2.5 | 2.5 | 2.5 | — | — | 2.5 |
| triethanolamine (part(s) by | | | | | | | |
| weight) | | | | | | | |
| Blending amount of | | 2.5 | 2.5 | 2.5 | — | — | 2.5 |
| phosphorus-containing organic | | | | | | | |
| titanate (part(s) by weight) | | | | | | | |
| Evaluation | Volume resistivity (×10⁻⁴ | 2.5 | 2.3 | 7.6 | 1.5 | 1.5 | 5.0 |
| | Ω · cm) | | | | | | |
| | Acetone rubbing test | ∘ | ∘ | ∘ | ∘ | ∘ | ∘ |
| | Solderability test | ∘ | ∘ | ∘ | Δ | x | Δ |
| | Adhesiveness with ITO | ∘ | ∘ | ∘ | ∘ | ∘ | ∘ |

| | | | Comparative | Comparative | Comparative | Comparative |
|---|---|---|---|---|---|---|
| | | | Example 4 | Example 5 | Example 6 | Example 7 |
| Powder | Blending | Flaky silver-coated | | | 100 | 100 |
| | amount | copper powder | | | | |
| | | (part(s) by weight) | | | | |
| | | Average particle | | | | |
| | | diameter: 8 μm to 10 μm | | | | |
| | | Silver coating | | | | |
| | | amount: 15 wt % | | | | |
| | | Flaky silver-coated | | | | |
| | | copper powder | | | | |
| | | (part(s) by weight) | | | | |
| | | Average particle | | | | |
| | | diameter: 5 μm to 7 μm | | | | |
| | | Silver coating | | | | |
| | | amount: 5 wt % | | | | |
| | | Spherical | | | | |
| | | silver-coated copper | | | | |
| | | powder (part(s) by | | | | |
| | | weight) | | | | |
| | | Average particle | | | | |
| | | diameter: 6 μm to 10 | | | | |
| | | μm | | | | |
| | | Silver coating | | | | |
| | | amount: 10 wt % | | | | |
| | | Flaky silver powder | 100 | | | |
| | | (part(s) by weight) | | | | |
| | | Average particle | | | | |
| | | diameter: 7 μm to 15 μm | | | | |
| | | Flaky copper powder | | 100 | | |
| | | (part(s) by weight) | | | | |
| | | Average particle | | | | |
| | | diameter: 8 μm to 10 μm | | | | |
| | Content of powder (wt % with | | 90 | 90 | 92.5 | 90 |
| | respect to the total of | | | | | |
| | binder components and | | | | | |
| | powder) | | | | | |
| Binder | Blending | Phenoxy resin | 6.6 | 6.6 | 4.9 | — |
| component | amount | (part(s) by weight) | | | | |
| | | Phenol resin (part(s) | — | — | — | 11.5 |
| | | by weight) | | | | |
| | | HDI-based | 4.9 | 4.9 | 3.2 | — |
| | | polyisocyanate | | | | |
| | | (part(s) by weight) | | | | |
| | | Blocked isocyanate | — | — | — | — |
| | | (part(s) by weight) | | | | |

| | Content of phenoxy resin | 57 | 57 | 60 | — |
|---|---|---|---|---|---|
| | (wt % with respect to the | | | | |
| | entirety of binder | | | | |
| | components) | | | | |
| Blending amount of | | 2.5 | 2.5 | 2.5 | 2.5 |
| triethanolamine (part(s) by | | | | | |
| weight) | | | | | |
| Blending amount of | | 2.5 | 2.5 | 2.5 | 2.5 |
| phosphorus-containing organic | | | | | |
| titanate (part(s) by weight) | | | | | |
| Evaluation | Volume resistivity (×10⁻⁴ | 1.1 | ∞ | 27 | 1.5 |
| | Ω · cm) | | | | |
| | Acetone rubbing test | ∘ | ∘ | Δ | ∘ |
| | Solderability test | x | Δ to x | x | ∘ |
| | Adhesiveness with ITO | ∘ | ∘ | ∘ | x |

As is apparent from Examples, according to the present invention, a conductive paste that can cure at low temperature and is excellent in solderability can be provided. In addition, it is found from the results of the acetone rubbing test that the conductive paste of the present invention has sufficiently cured. Such conductive paste can be prevented from being eroded by solder. Further, each of the conductive pastes obtained in Examples was excellent in adhesiveness with the ITO layer.

1. A conductive paste, comprising:
flaky silver-coated copper powder;
a phenoxy resin;
a hexamethylene diisocyanate-based polyisocyanate compound and/or a blocked isocyanate compound;
a phosphorus-containing organic titanate; and
an alkanolamine,
wherein a content of the flaky silver-coated copper powder is from 88 parts by weight to 92 parts by weight with respect to 100 parts by weight of a total amount of the flaky silver-coated copper powder, the phenoxy resin, and the hexamethylene diisocyanate-based polyisocyanate compound and the blocked isocyanate compound.

2. The conductive paste according to claim 1, wherein the flaky silver-coated copper powder has an average particle diameter of from 5 μm to 25 μm.

3. The conductive paste according to claim 1, wherein:
the flaky silver-coated copper powder includes copper particles each serving as a core and silver coating layers configured to coat the copper particles; and
a weight ratio of the silver coating layers is from 5 wt % to 20 wt % with respect to the copper particles.

4. The conductive paste according to claim 1, wherein a content of the phenoxy resin is from 40 parts by weight to 65 parts by weight with respect to 100 parts by weight of a total amount of the phenoxy resin, and the hexamethylene diisocyanate-based polyisocyanate compound and the blocked isocyanate compound.

5. The conductive paste according to claim 1, wherein a content of the phosphorus-containing organic titanate is from 1 part by weight to 3 parts by weight with respect to 100 parts by weight of the flaky silver-coated copper powder.

6. The conductive paste according to claim 1, wherein a content of the alkanolamine is from 1 part by weight to 3 parts by weight with respect to 100 parts by weight of the flaky silver-coated copper powder.
